(19) United States
(12) Patent Application Publication
(10) Pub. No.: US 2026/0129724 A1
(43) Pub. Date: May 7, 2026

(54) AUXILIARY HEATING ASSEMBLY WITH COMPLIANT CONNECTION COMPONENT

(71) Applicant: WHIRLPOOL CORPORATION, BENTON HARBOR, MI (US)

(72) Inventors: Xishuo Qiu, Shenzhen (CN); JunHua Wu, Shenzhen (CN); Laura Fossati, Travedona Monate (IT); Simone Polvara, Castellanza (IT)

(73) Assignee: WHIRLPOOL CORPORATION, BENTON HARBOR, MI (US)

(21) Appl. No.: 19/381,172

(22) Filed: Nov. 6, 2025

(30) Foreign Application Priority Data
Nov. 7, 2024 (WO) PCT/CN2024/130470

(51) Int. Cl. H05B 6/64

(52) U.S. Cl. CPC H05B 6/6417

(57) ABSTRACT

A microwave oven includes an interlock system including an interlock switch that cuts power to a magnetron of the oven when the interlock switch changes from a first state to a second state. The microwave oven further includes a door assembly having a door structure and a door hook that is configured to operably engage the interlock switch to cut power to the magnetron at a breaking point. The breaking point may be determined, at least in part, by a position of the door hook relative to the door structure. The door assembly further includes an adjustment assembly including a gear that is configured to shift the door hook relative to the door structure when the gear is rotated, and a lock member that locks the door hook in a selected position relative to the door structure whereby the breaking point can be adjusted.

### CROSS-REFERENCE TO RELATED APPLICATION

This application is a continuation of International Application No. PCT/CN2024/130470, filed on Nov. 7, 2024, entitled “AUXILIARY HEATING ASSEMBLY WITH COMPLIANT CONNECTION COMPONENT,” the entire disclosure of which is hereby incorporated herein by reference.

### BACKGROUND OF THE DISCLOSURE

The present disclosure generally relates to microwave ovens, and more specifically, to an adjustable door hook that actuates an interlock switch and turns the oven off when the oven door is opened.

### SUMMARY OF THE DISCLOSURE

An aspect of the present disclosure is a microwave oven including a housing forming a cavity and a magnetron that is configured to produce microwaves in the cavity when power is supplied to the magnetron. The microwave oven includes an interlock system having an interlock switch that cuts power to the magnetron when the interlock switch is shifted from a first state to a second state. The microwave oven further includes a door assembly that is operably coupled to the housing. The door assembly includes a door structure and a door hook that is configured to operably engage the interlock switch and shift the interlock switch from the first state to the second state to cut power to the magnetron at a breaking point. The breaking point is determined, at least in part, by a position of the door hook relative to the door. An adjustment assembly is operably coupled to the door hook. The adjustment assembly is configured to shift the door hook relative to the door structure to adjust the breaking point. The adjustment assembly includes a gear that shifts the door hook relative to the door structure when the gear is rotated, and a lock screw that is configured to retain the door hook in a selected position relative to the door structure when the lock screw is tightened.

Another aspect of the present disclosure is a microwave oven including a housing forming a cavity, and a magnetron that is configured to produce microwaves in the cavity when power is supplied to the magnetron. The microwave oven further includes an interlock system having an interlock switch that cuts power to the magnetron when the interlock switch changes from a first state to a second state. The microwave oven further includes a door assembly that is operably coupled to the housing. The door assembly includes a door structure and a door hook that is configured to operably engage the interlock switch to cut power to the magnetron at a breaking point. The breaking point is determined, at least in part, by a position of the door hook relative to the door structure. The door assembly further includes an adjustment assembly including a gear that is configured to shift the door hook relative to the door structure when the gear is rotated, and a lock member that locks the door hook in a selected position relative to the door structure whereby a position of the door assembly relative to the housing at the breaking point can be adjusted.

Another aspect of the present disclosure is a door hook assembly for a microwave oven. The door hook assembly includes a door hook base defining an interior space having an opening. A door hook has a first portion disposed within the interior space, and a second portion protruding outwardly through the opening. The door hook has an engagement element that is configured to engage an interlock system of a microwave oven. An adjustment assembly is operably coupled to the door hook. The adjustment assembly includes a gear that engages teeth on the door hook base to move the door hook relative to the door hook base. The door hook assembly further includes a lock member engaging the door hook. The lock member is movable between an unlocked condition and a locked condition, and the door hook is linearly translatable relative to the door hook base when the lock member is in the unlocked condition. The door hook is fixed to the door hook base when the lock member is in the locked condition.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an isometric view of a microwave oven according to an aspect of the present disclosure;

FIG. 2 is an isometric view of a door for a microwave oven;

FIG. 3 is a partially fragmentary exploded perspective view of a door hook assembly including a door hook and a door hook base according to an aspect of the present disclosure;

FIG. 3A is an end view of the base of the door hook assembly of FIG. 3;

FIG. 3B is a cross-sectional view of the base taken along the line 3B-3B; FIG. 3;

FIG. 4 is a cross-sectional view of the door hook assembly of FIG. 3 when it is assembled;

FIG. 4A is a fragmentary cross-sectional view of a portion of the door hook and base of FIG. 4;

FIG. 4B is a fragmentary isometric view of an upper side of a lower sidewall of the base;

FIG. 4C is an isometric view of the door hook showing the lower side thereof;

FIG. 4D is a fragmentary cross-sectional view of teeth on the door hook engaging teeth on the base;

FIG. 5 is a partially fragmentary cross-sectional view showing the door hook adjusted to a first position relative to the door structure of the microwave oven;

FIG. 6 is a partially fragmentary cross-sectional view showing the door hook adjusted to a second position relative to the door structure of the microwave oven; and:

FIG. 7 is a partially fragmentary cross-sectional view of the door hook when the door of the microwave oven is in a closed position.

The components in the figures are not necessarily to scale, emphasis instead being placed upon illustrating the principles described herein.

### DETAILED DESCRIPTION

The present illustrated embodiments reside primarily in combinations of method steps and apparatus components related to a door hook and interlock switch of a microwave oven. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

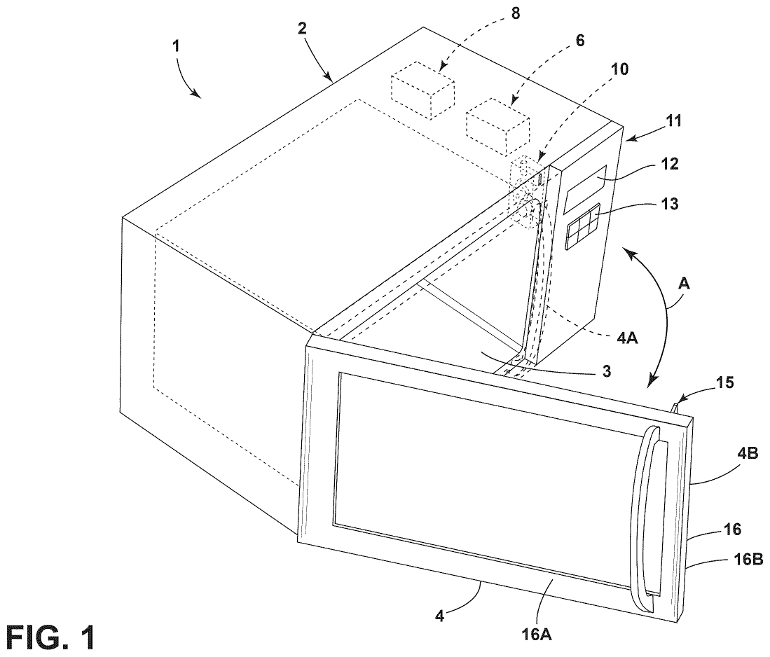

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

The present application is related to U.S. patent application Ser. No. 18/407,939, entitled “ADJUSTABLE DOOR HOOK ASSEMBLY,” (Atty. Docket No.: SUB-16491-US-NP), filed on Jan. 9, 2024, the entire contents of which are incorporated herein by reference.

With reference to FIG. 1, a microwave oven 1 according to an aspect of the present disclosure includes a housing 2 forming a cavity 3. A door 4 is movably mounted to the housing 2 for movement between a closed position 4A shown in dashed lines, and an open position 4B. Door 4 includes a door structure 16 having first and second portions 16A and 16B. Microwave oven 1 includes a controller 6 and a magnetron 8. Magnetron 8 is configured to produce microwaves in cavity 3 when power is supplied to the magnetron 8. As discussed in more detail below, door 4 includes an adjustable door hook assembly 15 that engages an interlock switch 10 to cut power to magnetron 8 as door 4 is opened. Oven 1 may include a user interface 11, which may include a display screen 12, push buttons 13, a touchscreen, or other suitable arrangement.

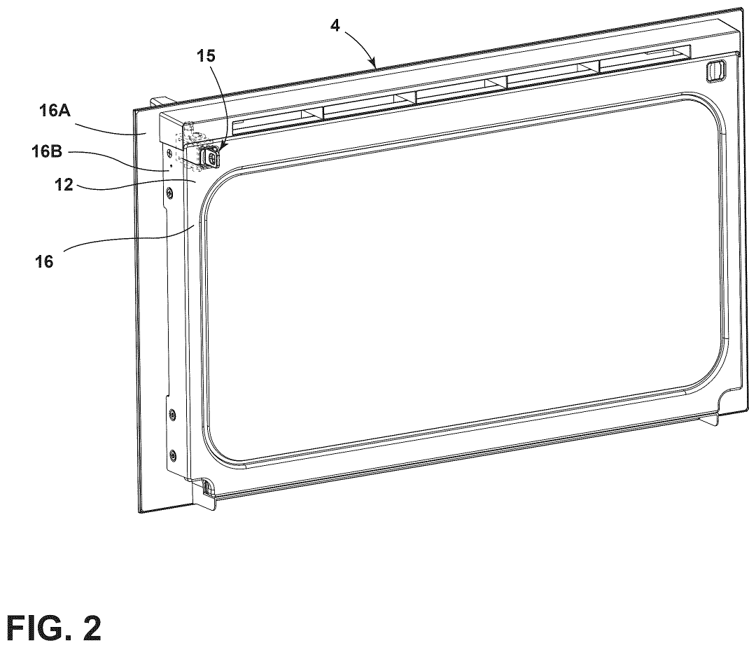

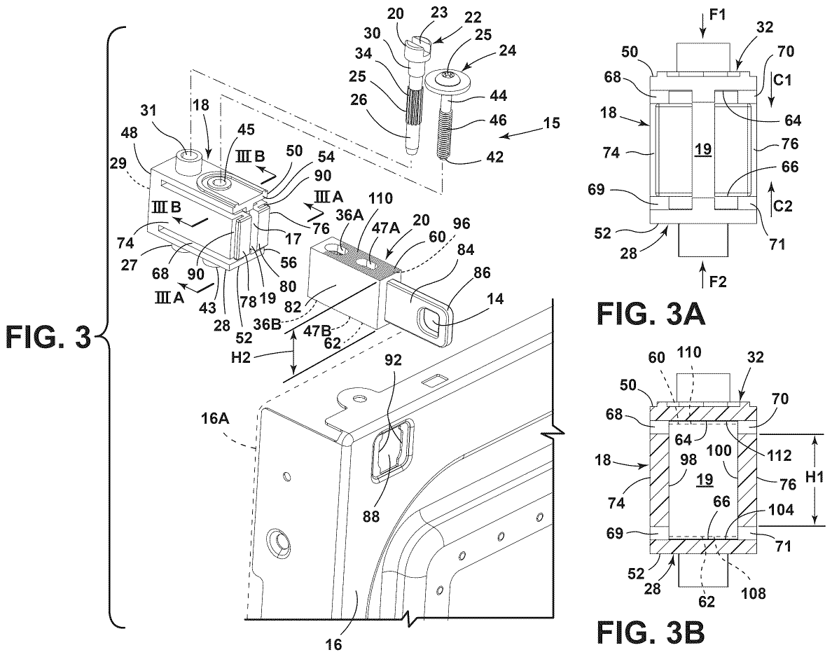

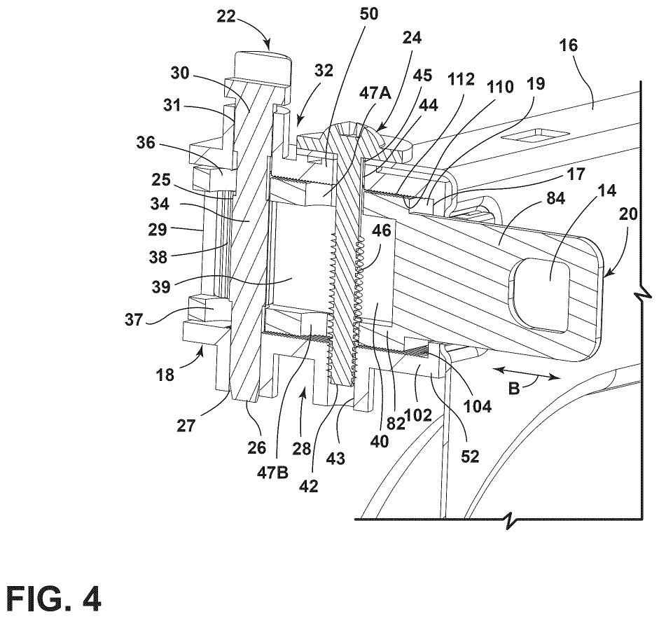

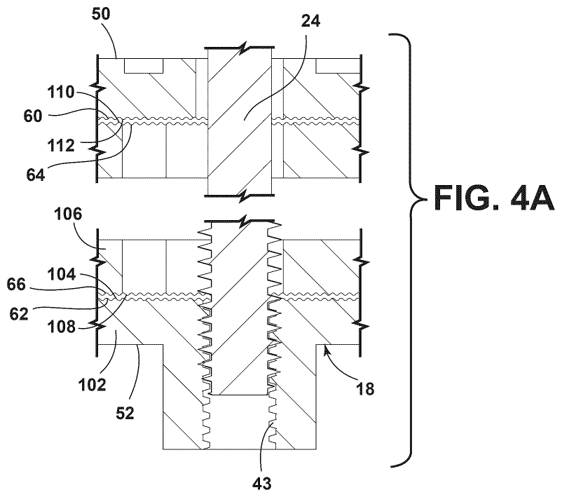

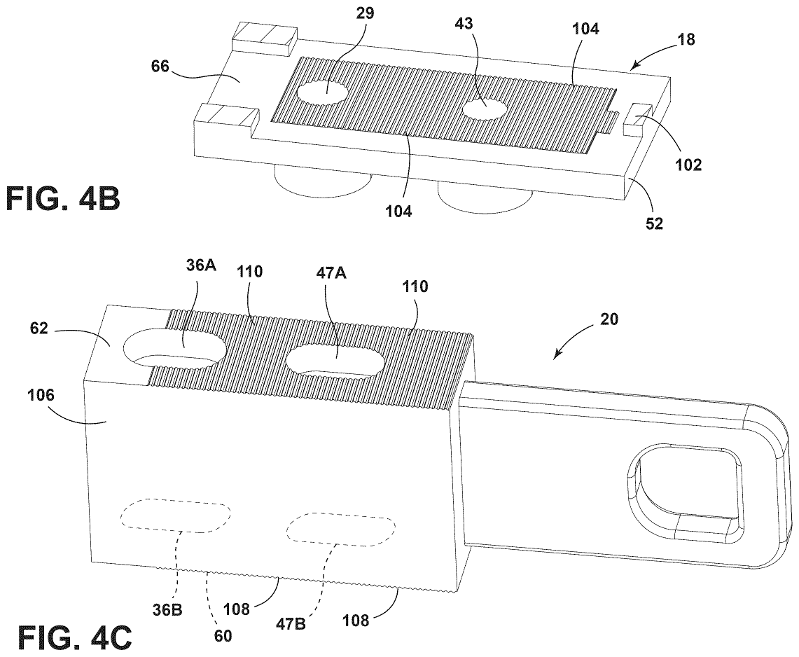

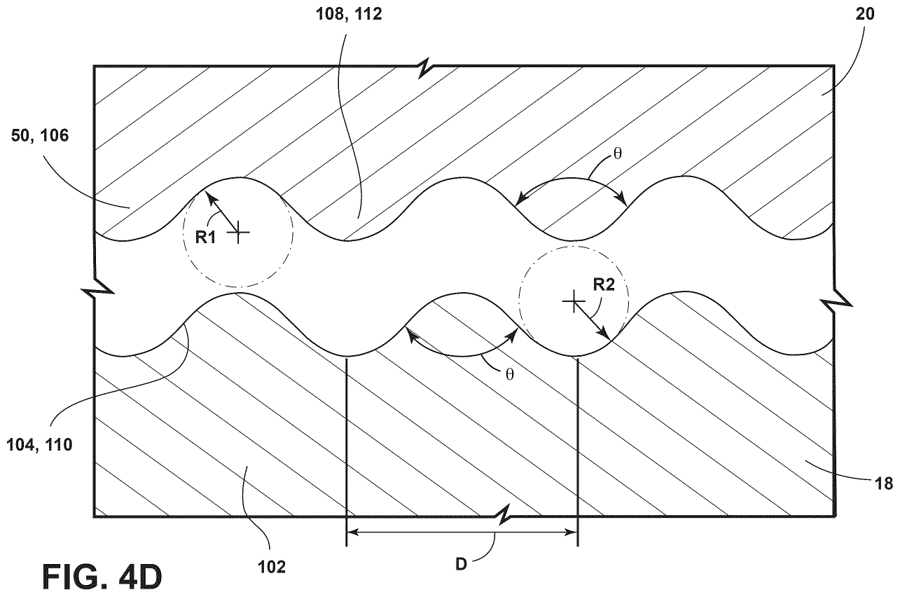

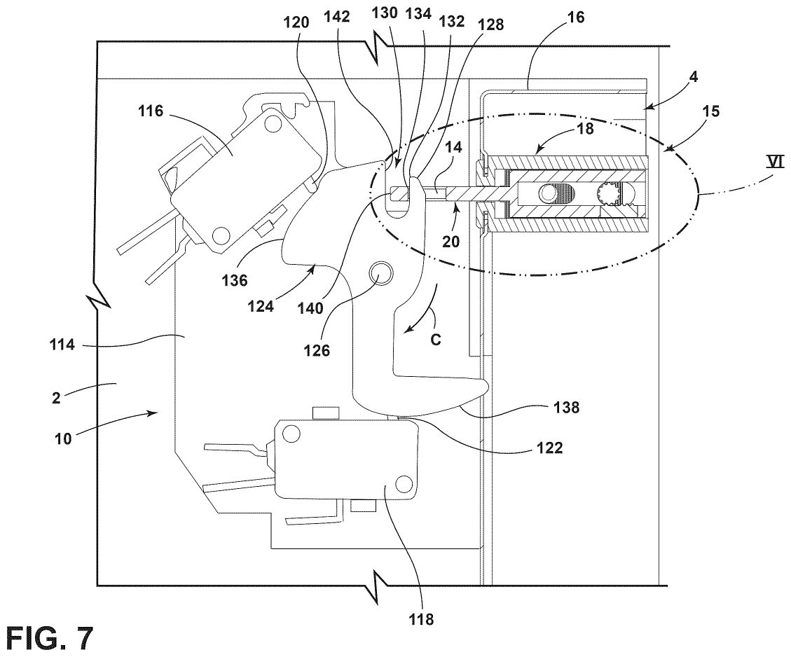

With further reference to FIGS. 2-4, door hook assembly 15 includes a base 18 and a door hook 20 that is at least partially disposed in an interior space or cavity 19 of base 18. Base 18 and door hook 20 may comprise a suitable material such as a composite (e.g. polymer matrix with glass fibers disposed in the matrix), a polymer, a metal, or any other suitable material or combinations of materials. As discussed in more detail below, door hook 20 may include an opening 14 (FIGS. 3 and 4) that engages interlock switch 10 to cut power to magnetron 8 when door 4 is opened. Door hook assembly 15 further includes a gear 22 and a lock screw 24. When assembled, lower end 26 of gear 22 is rotatably received in an opening 27 in lower sidewall 52 on a lower side 28 of base 18, and an upper portion 30 of gear 22 is rotatably received in an opening 31 in upper sidewall 50 on an upper side 32 of base 18. A central portion of gear 22 extends through elongated upper and lower slots 36A and 36B, respectively, of door hook 20. As discussed below, central portion 34 of gear 22 includes a plurality of teeth 25 that engage teeth 38 on an inner surface 39 of a cavity 40 of door hook 20 (see also FIGS. 6 and 7) to form a rack and pinion interface whereby rotation of gear 22 linearly shifts door hook 20 relative to base 20 as shown by the arrow “B” (FIG. 4).

When door hook assembly 15 is assembled, a threaded end portion 42 of lock screw 24 threadably engages a threaded opening 43 (FIG. 4) in lower sidewall 52 on lower side 28 of base 18, and an upper portion 44 of lock screw 24 is rotatably received in a clearance opening 45 in upper sidewall 50 on an upper side 32 of base 18. When assembled, central portion 46 of lock screw 24 extends through upper and lower elongated slots 47A and 47B, respectively, of door hook 20. Upper end 21 of gear 22 includes a slot formed by surfaces 23 that can be engaged by a tool (e.g. a flat screwdriver) or other suitable implement to thereby rotate the gear 22. Similarly, lock screw 24 may include a socket or cavity 25 to receive a tool to thereby rotate the lock screw 24.

With reference to FIGS. 3, 3A, and 3B, base 18 may comprise a material that is at least somewhat flexible to permit upper and lower sidewalls 50 and 52 to flex when lock screw 24 is tightened to thereby clamp the door hook 20 in place relative to the base 18. Upper and lower sidewalls 50 and 52, respectively, of base 18 are integrally formed with an end portion 48 of base 18 whereby the upper and lower sidewalls 50 and 52 have a cantilevered connection to end portion 48. End portions 54 and 56 of upper and lower sidewalls 50 and 52, respectively, can be moved inwardly towards door hook 20 when lock screw 24 is tightened as upper and/or lower sidewalls 50 and 52 of base 18 bend. Specifically, tightening of lock screw 24 generates forces generally shown by the arrows “F1” and “F2” (FIG. 3A) whereby the upper and lower sidewalls 50 and 52 flex and move as shown by the arrows “C1” and “C2.” As a result, the inner surfaces 64 and 66 of upper and lower sidewalls 50 and 52, respectively, clamp onto upper and lower surfaces 60 and 62, respectively, of door hook 20 (see also FIG. 3B), thereby clamping door hook 20 in position relative to base 18. When the lock screw 24 is tightened, gaps 68-71 between upper and lower sidewalls 50 and 52 and first and second opposite sidewalls 74 and 76 may also be reduced. However, dimension “H1” (FIG. 3B) of sidewalls 74 and 76 of base 18 is preferably smaller than dimension “H2” (FIG. 3) of door hook 20 such that gaps 68-71 do not completely close when lock screw 24 is tightened.

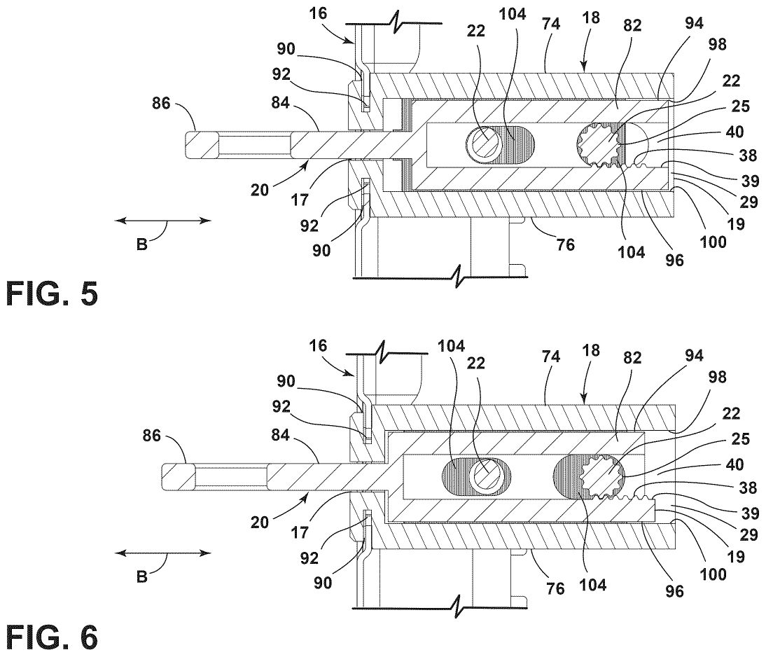

During assembly, door hook 20 can be assembled with base 18 by inserting hook 20 into opening 29 (FIGS. 5 and 6) of base 18, and a base portion of 82 of hook 20 may be positioned in an interior space 19 of base 18 with outer portion 84 of door hook 20 extending through and opening 17 in base 18 and protruding outwardly from opening 17 in base 18. When door hook 20 is positioned in interior space 19 of base 18, outer surfaces 94 and 96 of base portion 82 of door hook 20 may slidably engage inner surfaces 98 and 100, respectively, of base 18 (see also FIGS. 5 and 6).

The first and second opposite sidewalls 74 and 76 of base 18 may be integrally formed with end portion 48 of base 18 such that the sidewalls 74 and 76 are cantilevered to permit ends 78 and 80 (FIG. 3) of sidewalls 74 and 76, respectively, to be flexed inwardly to permit assembly of base 18 in opening 88 of door structure. Specifically, with reference to FIG. 3, during assembly forces may be applied to the end portions of sidewalls 74 and 76 to flex sidewalls 74 and 76 inwardly, and ends 78 and 80 of sidewalls 74 and 76 are then positioned in opening 88 of door structure 16. The inward forces on sidewalls 74 and 76 are then removed, and ends 78 and 80 of walls 74 and 76 move outwardly and flanges 92 of opening 88 are received in slots 90 of sidewalls 74 and 76 (see also FIGS. 5 and 6). After base 18 is attached to opening 88 of door structure 16, door hook 20 can be inserted into opening 29 of base 18. The outer surfaces 94 and 96 of door hook 20 may be closely spaced from inner surfaces 98 and 100 of sidewalls 74 and 76 of base 18. This may limit inward movement of sidewalls 74 and 76, thereby preventing disengagement of slots 90 from flanges 92. An outer portion 16A of door structure 16 may then be assembled to inner portion 16B of door structure 16 to close off opening 29 of base 18. This limits or prevents movement of door hook 20 out of opening 29 of base 18, even if gear 22 and lock screw 24 are removed.

With reference to FIGS. 4A-4C, upwardly facing inner surface 66 of lower sidewall 102 of base 18 may include upwardly facing teeth 104 adjacent to threaded opening 43. Lower side 62 of lower sidewall 106 of door hook 20 may include teeth 108 that engage teeth 104 of base 18 (door hook 20 is upside down in FIG. 4C). Teeth 104 and 106 are transverse (e.g. perpendicular) to the direction of movement “B” of hook 20 relative to base 18 during adjustment of the position of door hook 20 relative to base 18. Upper surface 60 of door hook 20 may include teeth 110 (FIGS. 3 and 4A) that engage teeth 112 on downwardly facing inner surface 64 of upper sidewall 50 of base 18 when lock screw 24 is tightened.

With reference to FIG. 4D, teeth 104, 108, 110 and 112 may have linear roots with a radius R1 and linear crests with a radius R2. The teeth may be spaced apart a distance “D” and the surfaces of the teeth may form angles θ. According to an example, D may be about 0.40 mm, and the angle θ may be about 45°. In general, dimension D may correspond to the smallest increment of adjustment (distance) of door hook 20 relative to base 18. Thus, dimension D may be selected to provide the desired adjustment increments as required for a particular application. It will be understood that teeth 104, 108, 110, and 112 are optional. For example, the surfaces of base 18 are door hook 20 may be free of teeth whereby friction due to tightening of lock screw 24 retains door hook 20 in an adjusted position. Also, teeth may be provided on only an upper or lower side of door hook 20 and/or base 18. Still further numerous other surface irregularities or features may be utilized to facilitate fixing the position of door hook 20 relative to base 18 when lock screw 24 is tightened. R1 and R2 may be relatively large (e.g. about 0.10 mm) to facilitate movement of hook 20 relative to base 18 when lock screw 24 is loose yet fixing the position of door hook 20 relative to base 18 when lock screw 24 is tightened to cause the teeth on base 18 to tightly engage the teeth of door hook 20. It will be understood that the teeth may have virtually any suitable size and configuration, and the shapes and dimensions described herein are merely examples of suitable configurations.

As discussed above, during assembly of microwave oven 1, base 18 can be secured to flanges 92 of opening 88 (FIG. 3) door hook 20 can be positioned in base 18. With further reference to FIGS. 5 and 6, the position of door hook 20 relative to base 18 can then be adjusted by loosening lock screw 24 (if necessary) and rotating gear 22. The engagement of teeth 25 of gear 22 with teeth 38 on inner side 39 of cavity 40 of door hook 20 causes the door hook 20 to shift relative to base 18. Specifically, the translational position of gear 22 is fixed relative to base 18 due to the engagement of gear 22 with openings 27 and 31 (FIG. 3) of base 18. When the desired position of door hook 20 relative to base 18 (and door structure 16) is reached, lock screw 24 is then tightened. As lock screw 24 is tightened, the upper and lower sidewalls 50 and 52 (FIGS. 3A and 3B) of base 18 flex and move towards the upper and lower surfaces 60 and 62, respectively, of door hook 20. The teeth 104 of base 18 engage teeth 108 of door hook 20, and teeth 112 of base 18 engage teeth 110 of door hook 20 when the lock screw 24 is tightened to thereby fix the position of door hook 20 relative to base 18. This prevents movement of door hook 20 in the direction of the arrow “B” (FIGS. 5 and 6).

The position of door hook 20 relative to base 18 may be adjusted to thereby adjust the breaking point. The breaking point may be the last moment (position) during opening of door 4 in which the interlock switch 10 change status, thus cutting power to magnetron 8. The position of door hook 20 relative to base 18 and door structure 16 may be set during initial assembly of the microwave oven. For example, the gear 22 and lock screw 24 may be accessible during final assembly of microwave oven 1, or immediately prior to final assembly of the microwave oven to thereby permit adjustment of the breaking point to account for tolerances that may be present in the microwave oven 1 and door 4 that could otherwise result in variability with respect to the breaking point.

With further reference to FIG. 7, interlock switch 10 may comprise a switch assembly including a first switch 116 and a second switch 118. The switches 116 and 118 may be mounted to a structure 114 of oven housing 2. A rotating member 124 is rotatably mounted to structure 114 by a shaft 126. Rotating member 124 includes a prong 128 forming an open-ended slot 130 adjacent prong 128. When door 4 is in a closed position, prong 128 is received in opening 14 of door hook 20. As door 4 is opened, surface 132 of prong 128 engages surface 134 of opening 14 of door hook 20, and door hook 20 causes rotating member 14 to rotate in the direction of the arrow “C” about shaft 126. As rotating member 124 rotates, a cam surface 136 of rotating member 124 causes switch member 120 of first switch 116 to shift, thereby causing switch 116 to change from a first state to a second state. When switch 116 changes states, power to magnetron 8 is cut.

Cam surface 136 may optionally comprise a first cam surface, and rotating member 124 may include a second cam surface 138. Cam surface 138 engages switch member 122 of second switch 118 as rotating member 124 is rotated. In the event switch 116 does not cut power to magnetron 8 as rotating member 124 is rotated, engagement of cam surface 138 with switch member 122 of switch 118 provides redundancy and cuts power to magnetron 8. For example, switches 116 and 118 may be connected in series such that a change of state of either or both switches 116 and 118 from closed to open cuts power to magnetron 8.

As door 4 is closed, end 140 of door hook 20 is received in the open end of slot 130 of rotating member 124, and end 140 of door hook 20 engages surface 142 of rotating member 124, thereby rotating the rotating member 124 in a direction opposite the arrow “C” until the rotating member 124 is returned to the position of FIG. 7.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A microwave oven, comprising:
a housing forming a cavity;
a magnetron that is configured to produce microwaves in the cavity when power is supplied to the magnetron;
an interlock system including an interlock switch that cuts power to the magnetron when the interlock switch is shifted from a first state to a second state; and:
a door assembly operably coupled to the housing, wherein the door assembly includes:
a door structure;
a door hook that is configured to operably engage the interlock switch and shift the interlock switch from the first state to the second state to cut power to the magnetron at a breaking point, wherein a position of the door hook relative to the door structure determines, at least in part, the breaking point; and:
an adjustment assembly operably coupled to the door hook, wherein the adjustment assembly is configured to shift the door hook relative to the door structure to adjust the breaking point, the adjustment assembly including a gear that shifts the door hook relative to the door structure when the gear is rotated, and a lock screw that that is configured to retain the door hook in a selected position relative to the door structure when the lock screw is tightened.

2. The microwave oven of claim 1, wherein:
the door hook is movably supported by a door hook base whereby the door hook moves linearly relative to the door structure when the gear is rotated.

3. The microwave oven of claim 2, wherein:
the door hook includes an elongated gear slot and teeth adjacent to a side of the gear slot; and:
the gear extends through the elongated gear slot and engages the teeth.

4. The microwave oven of claim 3, wherein:
the door hook is movably disposed in an interior space of the door hook base, the door hook base including first and second openings; and:
the gear rotatably engages the first and second openings.

5. The microwave oven of claim 4, wherein:
the door hook includes an elongated screw slot;
the lock screw extends through a first screw opening in the door hook base and through the elongated screw slot, the lock screw threadably engaging a threaded opening in the door hook base; and:
the threaded opening is on an opposite side of the door hook base relative to the first screw opening whereby rotation of the lock screw causes the door hook base to clamp onto and engage opposite sides of the door hook to fix a position of the door hook relative to the door hook base.

6. The microwave oven of claim 5, wherein:
the door hook and the door hook base include teeth that prevent movement of the door hook relative to the door hook base when the door hook base clamps onto and engages the opposite sides of the door hook.

7. The microwave oven of claim 1, wherein:
the interlock system includes a rotating member having a cam surface that engages the interlock switch and shifts the interlock switch from the first state to a second state when the rotating member is rotated in a first direction; and:
the door hook is configured to engage and rotate the rotating member in the first direction to cause the cam surface to engage the interlock switch and shift the interlock switch from the first state to the second state as the door assembly is moved from a closed position towards an open position.

8. The microwave oven of claim 7, wherein:
the door hook includes an opening;
the rotating member includes a prong and an engagement surface that is spaced apart from the prong to form a slot having an open outer end; and:
the prong extends into the opening of the door hook when the door is in the closed position; and:
movement of the door from the closed position causes the door hook to engage the prong and rotate the rotating member in the first direction to shift the interlock switch from the first state to the second state; and:
movement of the door to the closed position causes an end of the door hook to contact the engagement surface and rotate the rotating member in the second direction to shift the interlock switch from the second state to the first state.

9. A microwave oven, comprising:
a housing forming a cavity;
a magnetron that is configured to produce microwaves in the cavity when power is supplied to the magnetron;
an interlock system including an interlock switch that cuts power to the magnetron when the interlock switch changes from a first state to a second state; and:
a door assembly operably coupled to the housing for movement between open and closed positions relative to the housing, wherein the door assembly includes:
a door structure;
a door hook that is configured to operably engage the interlock switch to cut power to the magnetron at a breaking point, wherein the breaking point is determined, at least in part, by a position of the door hook relative to the door structure; and:
an adjustment assembly including a gear that is configured to shift the door hook relative to the door structure when the gear is rotated, and a lock member that locks the door hook in a selected position relative to the door structure whereby a position of the door assembly relative to the housing at the breaking point can be adjusted.

10. The microwave oven of claim 9, wherein:
the interlock system includes a rotating member; and:
the door hook is configured to rotate the rotating member to cause the interlock switch to change from the second state to the first state as the door assembly moves to the closed position, and wherein the door hook is configured to rotate the rotating member to cause the interlock switch to change from the first state to the second state as the door assembly is moved from the closed position.

11. The microwave oven of claim 9, wherein:
a relationship between the door hook and the interlock switch as the door assembly is moved from the closed position determines a point at which the interlock switch cuts power to the magnetron.

12. The microwave oven of claim 9, wherein:
the door hook is movably supported by a door hook base whereby the door hook moves linearly relative to the door structure when the gear is rotated; and:
the door hook includes a coupling portion engaging the door hook base and an engagement element extending from the coupling portion, and wherein the adjustment assembly is operably coupled to the coupling portion.

13. The microwave oven of claim 12, wherein:
the door hook includes an elongated gear slot and teeth adjacent to a side of the gear slot; and:
the gear extends through the elongated gear slot and engages the teeth.

14. The microwave oven of claim 13, wherein:
the door hook is movably disposed in an interior space of the door hook base between first and second interior surfaces of the door hook base, respectively; and:
the gear rotatably engages teeth disposed on a selected one of the first and second interior surfaces of the door hook base.

15. The microwave oven of claim 14, wherein:
the lock member comprises a lock screw;
the door hook includes an elongated screw slot;
the lock screw extends through a first screw opening in the door hook base and through the screw slot, the lock screw threadably engaging a threaded screw opening in the door hook base; and:
the threaded screw opening is on an opposite side of the door hook base relative to the first screw opening whereby rotation of the lock screw causes the door hook base to deform and clamp onto opposite sides of the door hook to prevent movement of the door hook relative to the door hook base.

16. A door hook assembly for a microwave oven, comprising:
a door hook base defining an interior space having an opening;
a door hook having a first portion disposed within the interior space, and a second portion protruding outwardly through the opening, the door hook having an engagement element configured to engage an interlock system of a microwave oven;
an adjustment assembly operably coupled to the door hook, the adjustment assembly including a gear that engages teeth on the door hook base to move the door hook relative to the door hook base; and:
a lock member engaging the door hook, wherein the lock member is movable between an unlocked condition and a locked condition, wherein the door hook is linearly translatable relative to the door hook base when the lock member is in the unlocked condition, and wherein the door hook is fixed to the door hook base when the lock member is in the locked condition.

17. The door hook assembly of claim 16, wherein:
the door hook includes an elongated slot with teeth adjacent to a side of the elongated slot; and:
the gear extends through the elongated slot and engages the teeth, and wherein a rotation of the gear drives linear translation of the door hook relative to the door hook base.

18. The door hook assembly of claim 17, wherein:
the gear includes a proximal portion having a head disposed outside the door hook base, a distal portion rotatably engaging an opening in the door hook base, and an intermediate portion between the proximal portion and the distal portion, the intermediate portion including teeth that engage the teeth of the door hook.

19. The door hook assembly of claim 16, wherein:
the lock member comprises a lock screw that threadably engages a threaded opening in the door hook base.

20. The door hook assembly of claim 19, wherein:
the door hook includes an elongated screw slot;
the lock screw extends through a first screw opening in the door hook base and through the screw slot, the lock screw threadably engaging a threaded screw opening in the door hook base;
the threaded screw opening is on an opposite side of the door hook base relative to the first screw opening whereby rotation of the lock screw causes the door hook base to deform and engage opposite sides of the door hook to prevent movement of the door hook relative to the door hook base; and:
the door hook and the door hook base include teeth that prevent movement of the door hook relative to the door hook base when the door hook base engages the opposite sides of the door hook.
